(19) United States
(12) Patent Application Publication
(10) Pub. No.: US 2007/0228857 A1
(43) Pub. Date: Oct. 4, 2007

(54) Apparatus for converting magnetic force to rotational torque

(76) Inventor: Alva D. Barnes, San Antonio, TX (US)

Correspondence Address: KAMMER BROWNING PLLC, 7700 BROADWAY, SUITE 202, SAN ANTONIO, TX, 78209, US

(21) Appl. No.: 11/729,452

(22) Filed: Mar. 28, 2007

Related U.S. Application Data
(60) Provisional application No. 60/786,557, filed on Mar. 28, 2006.

(51) Int. Cl. H02K 37/00; H02K 7/10; H02K 49/00

(52) U.S. Cl. 310/152; 310/103; 310/83; 310/46

(57) ABSTRACT

An efficient system for converting the energy associated with moving magnetic fields into a rotational torque. The system includes at least two stationary magnetic ribbons, each arranged in a generally semi-circular configuration and positioned about a central axis. A fixed hub assembly is positioned on the central axis. A rotating carousel assembly is positioned on the fixed hub. At least two spindles are supported on the carousel assembly. Rotation of the carousel assembly operates in conjunction with rotation of the spindles. At least two permanent magnets are positioned in pairs on the spindles. An output shaft is connected to the rotating carousel. The spindle magnets are attracted to the magnetic ribbons and as they are drawn towards them transfer this motion to the carousel assembly. The carousel assembly hands off the spindle magnets to the next magnetic ribbon regularly arranged around the rotation point on the fixed hub. In this manner the carousel assembly continues to rotate and transfers such rotational torque to the output shaft.

### CROSS REFERENCE TO RELATED APPLICATIONS

This application claims the benefit under Title 35 United States Code § 119(3) of U.S. Provisional Patent Application Ser. No. 60/786,557, filed Mar. 28, 2006, the full disclosure of which is incorporated herein by reference.

### BACKGROUND OF THE INVENTION

1. Field of the Invention

The present invention relates generally to rotating magnetic force converters. The present invention relates more specifically to a system for efficiently converting magnetic forces into rotational torque capable of doing work. This invention relates to a magnetic apparatus used primarily for the purpose of producing electricity.

2. Description of the Related Art

This is a magnetic force converter; it is designed to facilitate the creation of torque for the purpose of operating a generator, and to thereby facilitate the generation of energy for autos, dwellings or any other device or system that requires electricity.

The magnetic force converter is light weight, compact and almost maintenance free, it will last for an indefinite period of time unless exposed to extreme heat (250° F. or more) for a prolonged period of time. It will run in a sealed type container at ground level, underwater, or out of the earth's atmosphere, it operates without the burning of fuel, produces no emission and is practically noiseless.

Efforts in the past to gain the benefit of the ability of magnetic fields to direct rotational motion in a shaft have generally suffered with energy losses due to friction, heat, and other waste energy drains on the systems. In addition, efforts in the past have failed to address the process of efficiently handing off rotating magnetic elements from one fixed magnetic field to the next in the radial rotating environment. It would be desirable to have a system that overcame many of the problems found in the prior art in a manner that produced a more efficient and more complete transfer of energy from moving magnetic fields to rotational torque.

### SUMMARY OF THE INVENTION

The objective of this invention is to provide a power source for a generator in order to enable an auto, dwelling or any other device or system that requires electricity to become self sufficient. The present invention provides an efficient means for converting the energy associated with moving magnetic fields into a rotational torque from which work may be accomplished. The system of the invention provides at least two stationary magnetic ribbons, each arranged in a generally semi-circular configuration and positioned about a central axis. A fixed hub assembly is positioned on the central axis and is fixed in relation to the stationary magnetic ribbons. A rotating carousel assembly is positioned on the fixed hub and rotates thereon. At least two spindles are supported on the carousel assembly and connected through it to the fixed hub by way of a motion transfer means (such as gear assemblies and belt assemblies) whereby the rotation of the carousel assembly on the fixed hub operates in concert with the rotation of the spindles on the carousel assembly. At least two permanent magnets are positioned in pairs on the spindles, generally radially opposite each other on the spindles. These spindle magnets are positioned in spaced proximity to the magnetic ribbons but do not come into direct contact with the magnetic ribbons at any point in their movement, either about the spindle or on the carousel assembly about the fixed hub. An output shaft is connected to the rotating carousel.

The magnets positioned on the spindle are attracted to the magnetic faces of the magnetic ribbons and as they are drawn towards the magnetic ribbons serve to transfer this motion to the carousel assembly. The combined process of turning the spindles and the carousel assembly maintains the spaced distance between the magnetic ribbons and the spindle magnets. The curved configuration of the magnetic ribbons allows the attractive magnetic force to be maintained throughout a significant arc of rotation by the carousel assembly. At the end of the magnetic ribbon, the carousel assembly “hands off” the spindle magnets to the next magnetic ribbon regularly arranged around the rotation point of the carousel assembly on the fixed hub. In this manner the carousel assembly continues to rotate and transfers such rotational torque to an output shaft.

### BRIEF DESCRIPTION OF THE DRAWINGS

The accompanying figures will give a fuller description and a better understanding of the details and advantages of the invention.

FIG. 1 is a perspective view showing the magnetic force converter unit in its fully assembled form.

FIG. 2 is a perspective view of the unit of the present invention with the upper half of the case/housing removed showing the internal assembly.

FIG. 3 is a top view of the unit without the upper case/housing.

FIG. 4 is a horizontal cross section of the complete unit, exposing all of the internal parts.

FIG. 5 is a perspective view of the unit without the outer case/housing and a quarter cross section cut showing all of the internal parts.

FIG. 6 is a detailed horizontal cross section of the hub assembly showing a full view of all of the internal parts.

### DETAILED DESCRIPTION OF THE PREFERRED EMBODIMENT

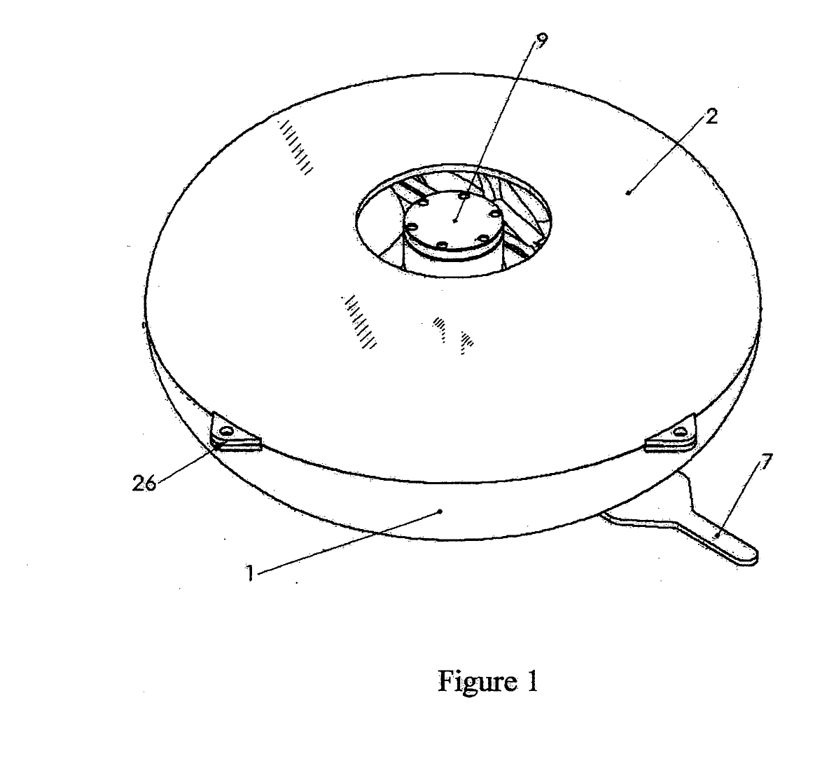

Each specific part bears the same number throughout FIGS. 1-6.

FIG. 1 is a view of the unit in its complete assembly with 1 and 2 being the lower and upper case/housing which is a two part split case/housing. The power adjust lever 7 controls the force of the magnets by rotating the case/housing and moving the magnets in and out of the force range. The ears 26 allow the upper and lower case/housing half's to be bolted together. The output shaft 9 is a flange that is bolted to the hub assembly to transfer the power.

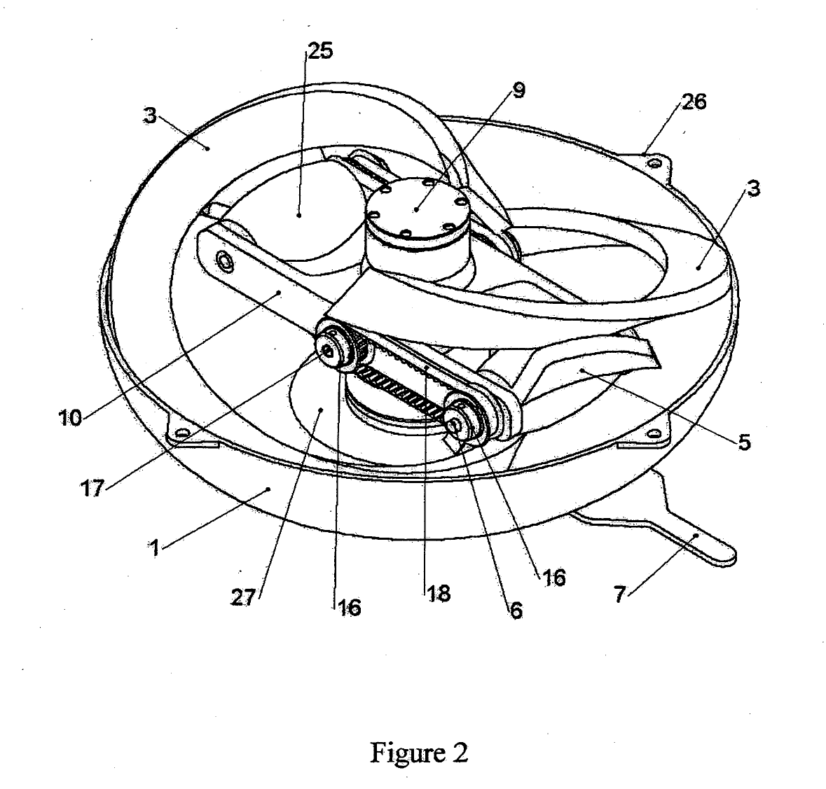

FIG. 2 is a perspective view of the unit with the upper half of the case/housing 2 removed showing the internal assembly. The lower half of the case/housing 1 contains the stationary magnetic ribbons 3 that constitute one part of the power source and are attached to the lower case/housing 1. The spindle magnets 5 are the other half of the power source. Both the stationary magnet ribbons 3 and the spindle magnets 5 work with an attracting magnetic field. The spindle magnet 5 is pulled toward the stationary magnetic ribbon 3 for one hundred eighty plus degrees and then is handed off to the other spindle magnet 5 and continues to travel to create a full three hundred and sixty degree turn and thus rotating the carousel 10. The gap between the spindle magnet 5 and the stationary magnetic ribbon 3 is approximately ¼ inch. The spindle magnets 5 are mounted on the spindle 25, the spindle 25 is pinned to the spindle shaft 6 and the belt pulley is attached to the spindle shaft 6 with a set screw 24. The belt is transferring the rotary motion to the pulley 16 on the transfer shaft 17 which turns transfer gear 15 and sets the hub 22 in a rotary motion through the hub drive gear 14 and therefore is spinning the carousel. As in FIG. 1 the power adjust lever 7 controls the distance between the spindle magnets 5 and the stationary magnetic ribbons 3 by rotating the case/housing 1 & 2 to control the force/power.

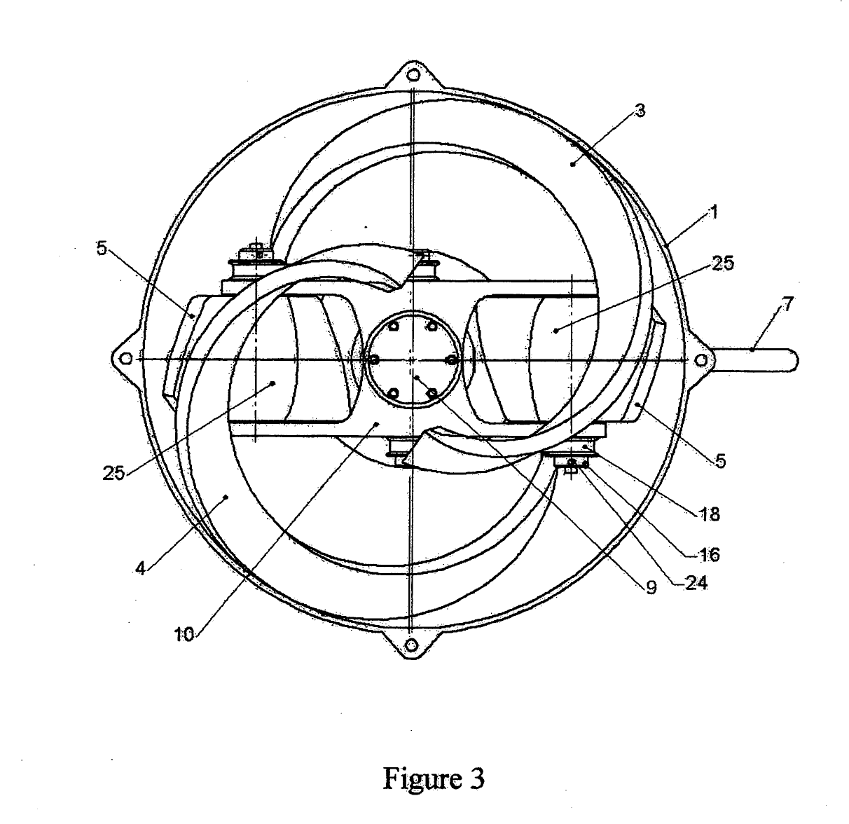

FIG. 3 is a top view with the upper case/housing 2 removed, showing all the main components, the lower case/housing 1, the stationary magnetic ribbons 3, the spindle 25, the spindle magnets 5, the carousel 10, the pulley and belt 16 and 18, and the output shaft 9. The spindle magnets 5 and the stationary magnetic ribbons 3 are working in attracting magnetic fields which produces the power that makes the carousel 10 rotate. The output shaft 9 is connected with a flange to the carousel 10 and therefore transferring the power to the output shaft 9.

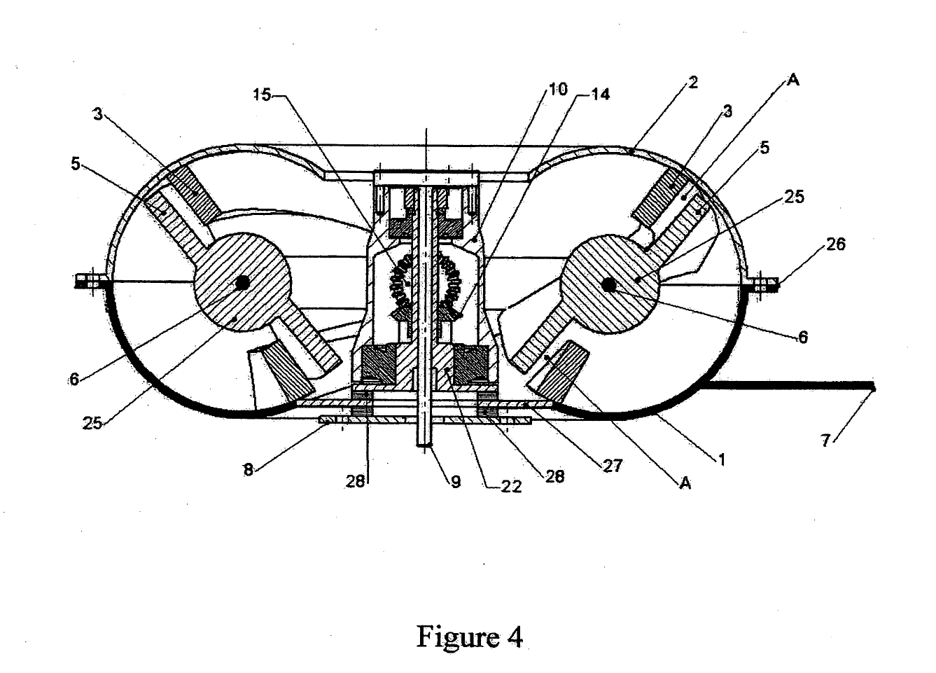

FIG. 4 is a horizontal cross section of the complete unit exposing all of the internal parts. The wafer bearings 28 are sandwiched between the base plate 27 and the hub flange 22 and the unit mounting plate 8, this enables the case/housing 1 & 2 to be rotated with the power adjust lever 7. The hub flange 22 is bolted to the unit mounting plate 8. The rotation of the case/housing 1 & 2 will increase or decrease the distance A between the spindle magnets 5 and the stationary magnetic ribbons 3, and thus increase or decrease the torque on the output shaft 9.

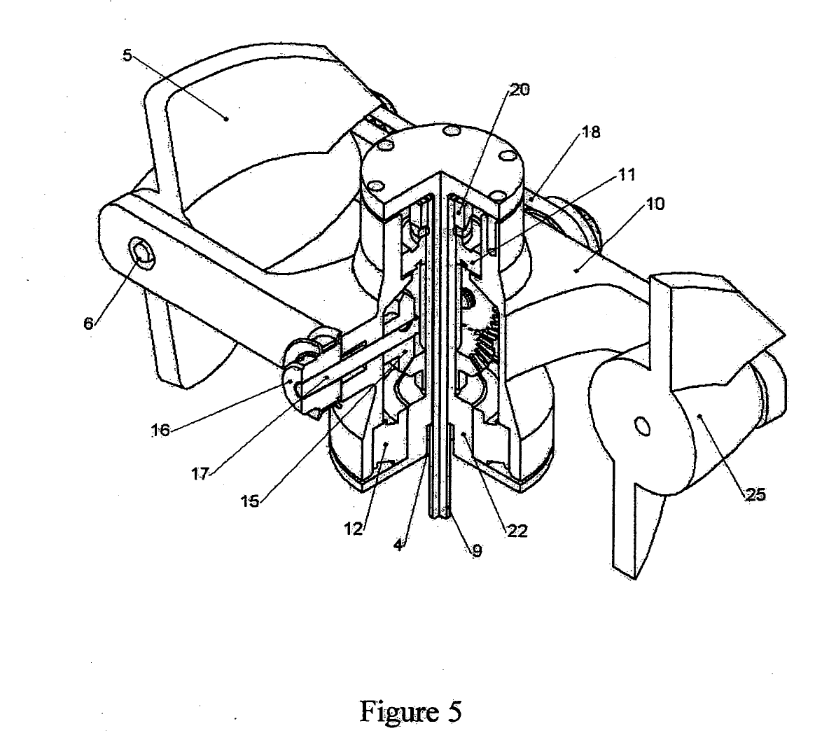

FIG. 5 is a perspective view of the unit without the outer case/housing 1 & 2 and a quarter cross section cut showing all the internal parts. Exposed are the outer thrust bearing 11 and the inner thrust bearing 12, the hub 22, the output shaft 9 and the set of the three matching gears 14 and 15. The carousel 10 travels around in a clock wise motion using a set of three matching gears at a ratio of 1:1. The two transfer gears 15 walk around the hub drive gear 14 bringing the carousel 10 in motion and therefore turning the output shaft 9. The carousel 10 is held on to the hub 22 with a hub retainer nut 20 and the carousel 10 rotates around the hub 22. The pulley 16 and the belt 18 transfer the torque from the spindle 25 to the transfer shaft 17.

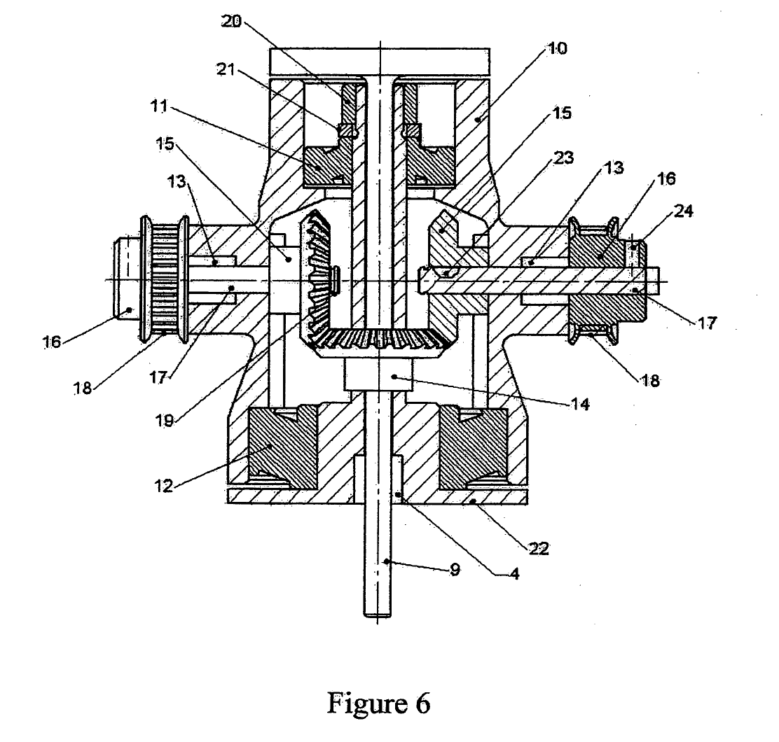

FIG. 6 is a detailed horizontal cross section of the hub assembly showing a full view of all the internal parts. The hub assembly consists of the hub 22 and the carousel 10 which are mounted with an inner and an outer thrust bearing 12 and 11 and held together by a hub retainer nut 20. The hub drive gear 14 is attached to the hub 22 and the hub bottom flange is attached to the unit mounting plate 8 which makes the hub 22 the stationary part and the carousel 10 the moving part.

Basic elements of the system of the present invention are described briefly above and are provide in greater detail on the attached drawings. The following comprises a list of the component elements in the drawings which are consistent throughout the drawing figures.

### LIST OF PARTS

1. Lower case/housing
2. Upper case/housing
3. Stationary magnet ribbon
4. Output shaft bearing
5. Spindle magnet
6. Spindle shaft
7. Power adjust lever
8. Unit mounting plate
9. Output shaft
10. Carousel/Housing
11. Outer trust bearing
12. Inner trust bearing
13. Transfer shaft bearing
14. Hub drive gear
15. Transfer gear
16. Pulley
17. Transfer shaft
18. Belt
19. Snap ring retainer
20. Hub retainer nut
21. Flat washer
22. Hub
23. Key
24. Set screw
25. Spindle
26. Alignment ear
27. Base plate
28. Wafer bearing

Although the present invention has been described in conjunction with a number of preferred embodiments, those skilled in the art will recognize modifications to the design that still fall within the spirit and scope of the invention. Modifications as to size and geometry will likely be required for operational systems of the present invention directed to different applications. In general, these modifications as to size would simply scale up or scale down the components as described herein, although certain functional components may not be sized directly to scale. In addition, although the preferred embodiment described herein is based upon utilization of an attractive magnetic force, certain modifications to the basic design of the system may enable the utilization of an opposing magnetic field force instead of an attractive magnetic force. Nonetheless, it is the preferred embodiment of the present invention that an attractive magnetic force be utilized to direct the rotational motion of the system. Other modifications to the system of the present invention will be apparent to those skilled in the art, which modifications do not necessarily depart from the scope of the invention as set forth in the appended claims.

I claim:

1. An apparatus for converting magnetic force to rotational torque, the apparatus comprising:
at least two stationary magnetic ribbons, the magnetic ribbons each establishing fixed magnetic fields extending from the surfaces of the ribbon, the at least two magnetic ribbons each arranged in a generally semi-circular configuration and positioned about a central axis;
a fixed hub positioned generally on the central axis and fixed in relationship to the stationary magnetic ribbons;
a rotating carousel assembly positioned on the fixed hub and rotatable thereon, the carousel assembly supporting at least two spindles, the two spindles connected through the carousel assembly to the fixed hub by way of a motion transfer means whereby rotation of the carousel assembly on the fixed hub occurs in conjunction with rotation of the spindles on the carousel assembly;
at least two permanent spindle magnets positioned in pairs on each of the at least two spindles, each of the permanent spindle magnets in a pair positioned radially opposite each other on each of the spindles; and
an output shaft connected to the rotating carousel;
wherein the spindle magnets are positioned in close spaced proximity to the magnetic ribbons and the magnetic force experienced between the spindle magnets and the magnetic ribbons directs the rotation of each of the spindles and through the motion transfer means thereby to rotate the carousel assembly on the fixed hub thereby resulting in a rotational torque on the output shaft.
